(19) United States
(12) Patent Application Publication
(10) Pub. No.: US 2012/0007814 A1
(43) Pub. Date: Jan. 12, 2012

(54) Touch Display Device and Electronic Device Using the Same

(76) Inventor: Yu-Fu Tung, Taipei Hsien (TW)

(21) Appl. No.: 12/909,858

(22) Filed: Oct. 22, 2010

(30) Foreign Application Priority Data
Jul. 7, 2010 (TW) 099212966

(51) Int. Cl. G06F 3/041

(52) U.S. Cl. 345/173

(57) ABSTRACT

A touch display device includes a housing, a flexible monitor installed on the housing, and at least one keystroke device installed inside the housing and under the flexible monitor for generating at least one trigger signal. When the flexible monitor are pressed by external forces at positions corresponding to the at least one keystroke device, deformation of the flexible monitor occurs and further press the at least one keystroke device, to make the at least one keystroke device to generate the at least one trigger signal.

### BACKGROUND OF THE INVENTION

1. Field of the Invention

The present invention relates to a touch display device and related electronic device, more particularly, to a touch display device and related electronic devices with low cost, low power consumption, supporting multi-touch function easily and large-size applications.

2. Description of the Prior Art

A touch display device has merits of convenient operation, rapid response, and saving space, such that the touch display device has become an important input interface, and been widely used in various consumer electronic products, such as electronic books, personal digital assistants, smart mobile phones, notebooks, and point of sale systems (POS). Specifically, the touch display device is composed of a display device and a transparent touch pad, and in detail, is made by fixing the transparent touch pad onto the display device, to fulfill both touch and display functions. The operation principle of the touch pad is well known for those skilled in the art, where the capacitive touch technique has stable performance, excellent sensitivity and durability, and is the most popular touch technique.

Please refer to FIG. 1A and FIG. 1B. FIG. 1A is a schematic diagram of a prior art touch display device 10, and FIG. 1B is a cross-sectional diagram of the touch display device 10 along point A to point A′. The touch display device 10 is composed of a liquid crystal display (LCD) panel 100 and a transparent touch pad 102. The liquid crystal display (LCD) panel 100 and the transparent touch pad 102 are agglutinated together by glue or other materials. The transparent touch pad 102 is a capacitive touch pad made by transparent materials and detects capacitance variations caused by contact of external objects. The detected capacitance variations are provided to a control module for determining touch events. Please refer to FIG. 2, which illustrates a structure of the transparent touch pad 102. The transparent touch pad 102 is mainly composed of sense capacitor sequences X₁-Xₘ and Y₁-Yₙ disposed on a substrate 200. Each sense capacitor sequence is a one-dimensional structure formed by a sequence of sense capacitors. The prior art touch detection method detects capacitance of each sense capacitor sequence to determine whether a touch event occurs. Assume that the sense capacitor sequence X₃ includes “a” pieces of sense capacitors and the capacitance of each sense capacitor is C. Under normal conditions, the capacitance of the sense capacitor sequence X₃ is aC. If capacitance variation caused by human body (e.g. a finger) touching a sense capacitor of the sense capacitor sequence X₃ is ΔC, then a touch event on the sense capacitor sequence X₃ can be detected when the capacitance of the sense capacitor sequence X₃ is ac+ΔAC. Accordingly, as shown in FIG. 2, while a finger touches an intersection of the sense capacitor sequences X₃ and Y₃, the capacitances of the sense capacitor sequences X₃ and Y₃ vary at the same time, and a control module is able to determine that the touch sensing point is at (X₃, Y₃).

To detect the capacitance variation on the transparent pad, the discharge time of each sense capacitor sequence is calculated to determine whether a touch event occurs on corresponding sense capacitor sequence. For example, while detecting whether capacitance of the sense capacitor sequence X₃ changes, a high-level (logic 1) signal is emitted to the sense capacitor sequence X₃, and keeps detecting variation of the high-level signal. Then, the duration that the level of the high-level signal decreases to a predetermined low level is counted. If the duration exceeds a predetermined value, it represents that the capacitance of the sense capacitor sequence has increased, and a touch event occurs. Otherwise, no touch event is happened. Repeating such detection procedure can determine whether a touch event occurs, or where and when a touch event occurs.

Therefore, as to the touch event detection method of the transparent touch pad 102, the prior art must perform detection for each sense capacitor sequence. Under such circumstances, as a size of the touch pad increases, for example, for a large touch display device, the influence and the variation range of the environmental capacitance also increase, resulting in difficulties in practice. Meanwhile, the size increase of the touch pad accompanies time increase for completing the detection cycles, which may cause the incapability of timely reflecting the variation of the touch event, and affect the utilization convenience.

In addition, since the transparent touch pad 102 sequentially detects each sense capacitor sequence, when a sense capacitor sequence has two touch points, generally, the prior art capacitive technique can only detect that a touch event occurs in the sense capacitor sequence, but has difficulties to identify the two touch points and the corresponding positions. In other words, the prior art capacitive technique is generally suitable for a single-touch application, and needs to incorporate complex detecting and calculating algorithms with excess cost if applied for a multi-touch application.

Furthermore, the touch function is not necessary for all display positions. For example, please refer to FIG. 3. FIG. 3 is a schematic diagram of an electronic book 30. The electronic book 30 includes a capacitive touch display 300 for fulfilling both touch and display functions. When a user reads digital data via the electronic book 30, the touch display 300 displays keys 302 and 304 for switching pages. However, due to the capacitive touch technique detection method, even if the user may only select the keys 302 and 304 to switch pages, the touch display 300 still detects the capacitance variation of all touch positions and further causes more power consumption, especially as demerits of portable electronic devices such as the electronic book 30. Certainly, the electronic book 30 may be appropriately modified to detect only the keys 302 and 304 when displaying digital data. However, such modification is involved in altering algorithms and has difficulties in practice.

As to the electronic books or other applications with less control function, touch keys may be replaced with traditional mechanical keys whose demerit is only few and fixed characters can be displayed in limited areas for showing corresponding functions. To improve the disadvantage, CN published patent application CN201123028Y discloses keys with display panels, which installs electronic ink display panels on mechanical keys in order to change and increase information displayed by the keys. However, the electronic ink display panel is not a part of a display panel installed on a handset (the patent application is applicable for a handset) and a structure of the electronic ink display panel is still composed of mechanical keys, for example, keycaps, springs, etc. Therefore, the total cost still increases substantially.

### SUMMARY OF THE INVENTION

It is therefore an objective of the present invention to provide a touch display device and related electronic device.

The present invention discloses a touch display device, which comprises a housing; a flexible monitor, installed on the housing; and at least one keystroke device, installed inside the housing and under the flexible monitor, for generating at least one trigger signal; wherein when the flexible monitor is pressed by an external force at positions corresponding to the at least one keystroke device, deformation of the flexible monitor occurs and further presses the at least one keystroke device, to make the at least one keystroke device to generate the at least one trigger signal.

The present invention further discloses an electronic device, which comprises an operation circuit, for generating an image signal; a touch display device comprising: a housing; a flexible monitor, installed on the housing; and at least one keystroke device, installed inside the housing and under the flexible monitor, for generating at least one trigger signal to the operation circuit to control the operation circuit; wherein when the flexible monitor is pressed by an external force at positions corresponding to the at least one keystroke device, deformation of the flexible monitor occurs and further presses the at least one keystroke device, to make the at least one keystroke device to generate the at least one trigger signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a touch display device according to the prior art.

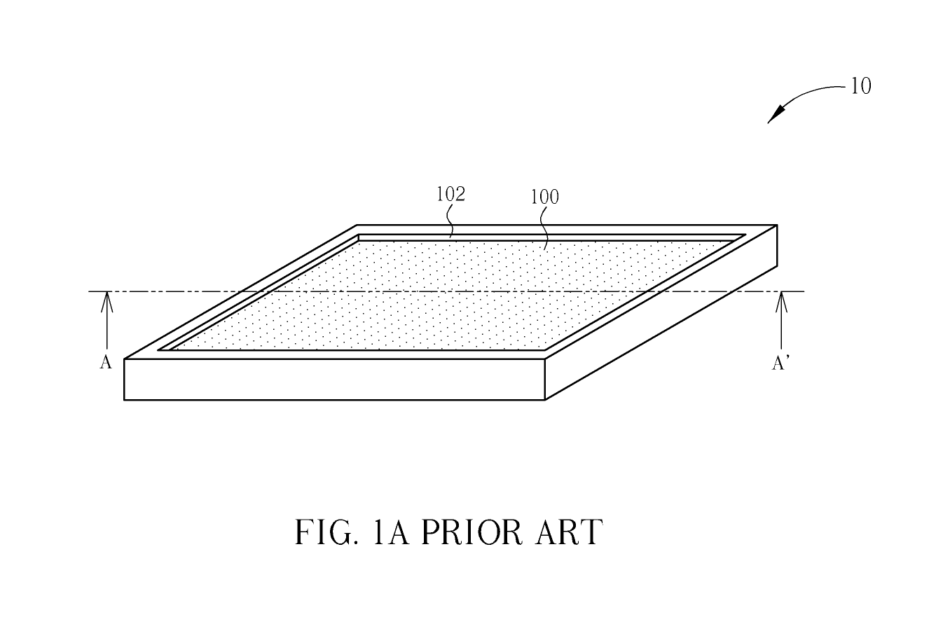

FIG. 1B is a cross-sectional diagram of the touch display device in FIG. 1A.

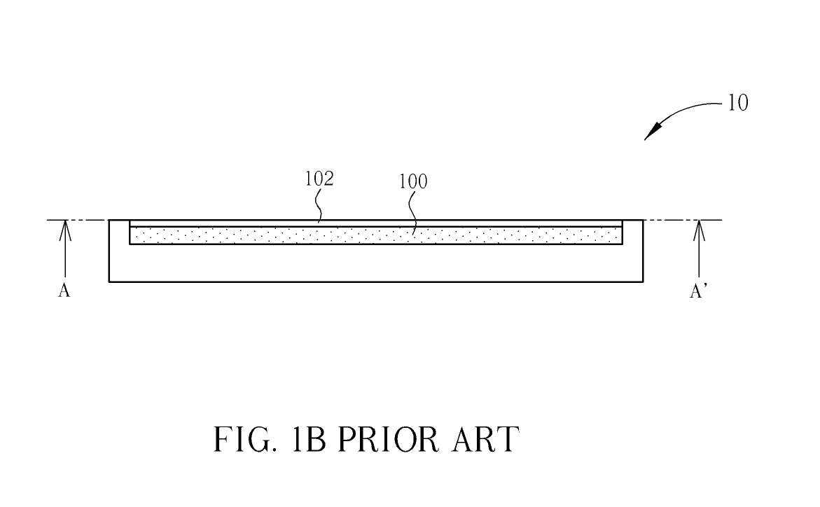

FIG. 2 is a schematic diagram of a transparent touch pad in FIG. 1A.

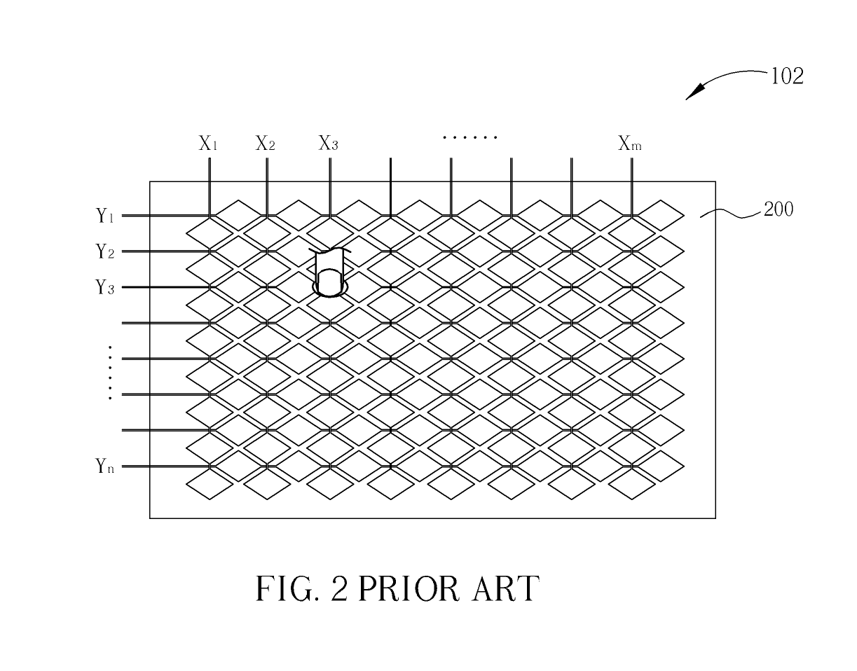

FIG. 3 is a schematic diagram of an electronic book according to the prior art.

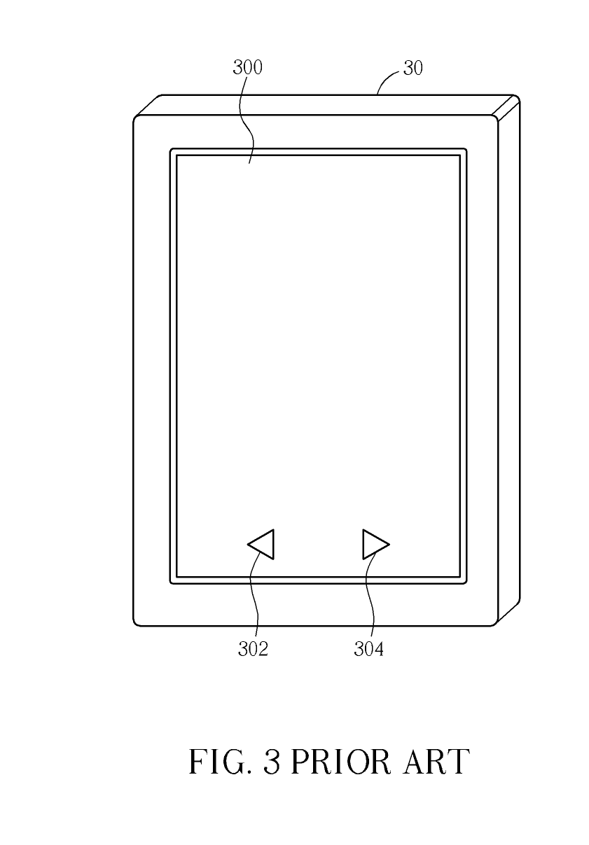

FIG. 4A is a schematic diagram of a touch display device according to an embodiment of the present invention.

FIG. 4B is a cross-sectional diagram of the touch display device in FIG. 4A.

FIG. 4C is a schematic diagram of a keystroke device in FIG. 4A.

FIG. 5 is a schematic diagram of an electronic book according to an embodiment of the present invention.

FIG. 6 is a schematic diagram of a touch display device according to an embodiment of the present invention.

### DETAILED DESCRIPTION

To improve disadvantages of the prior art touch display device, the present invention utilizes a flexible characteristic of an electronic paper for realizing a touch display device with power saving, low cost and supporting multi-touch function.

First, a basic principle of the electronic paper is to use microcapsule technology to wrap electrophoretic liquid as well as suspended pixel particles into nano-sized microcapsules so as to form electronic ink. When different electrical fields are applied to the top side of the microcapsule, the pixel particles move upward. In such a manner, the microcapsule shows colors. Accordingly, via the control of the electrical fields, the specifically-arranged microcapsules may show images cooperatively. Meanwhile, if the specifically-arranged microcapsules are disposed between flexible backplane and frontplane, the specifically-arranged microcapsules have a flexible characteristic.

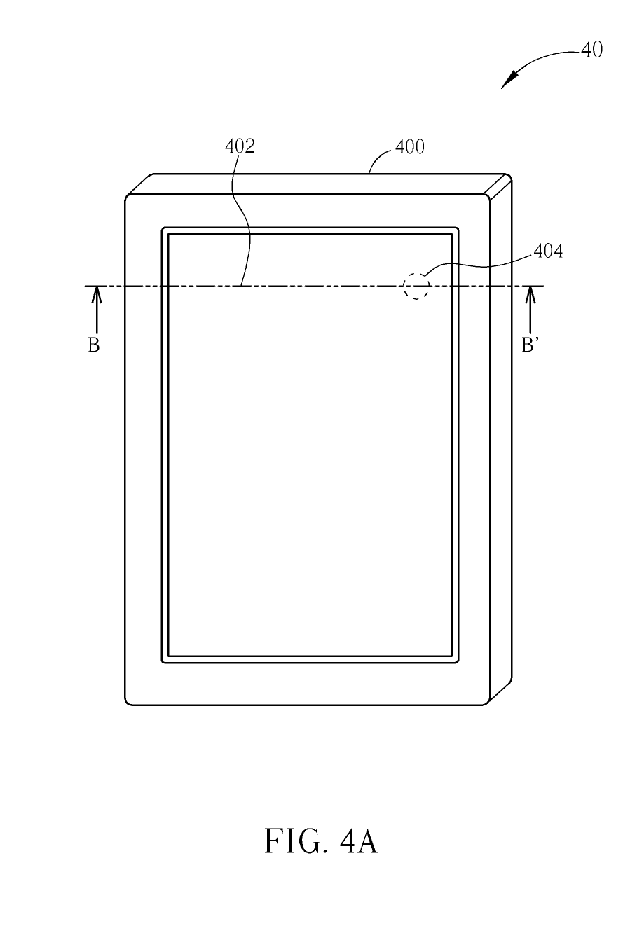

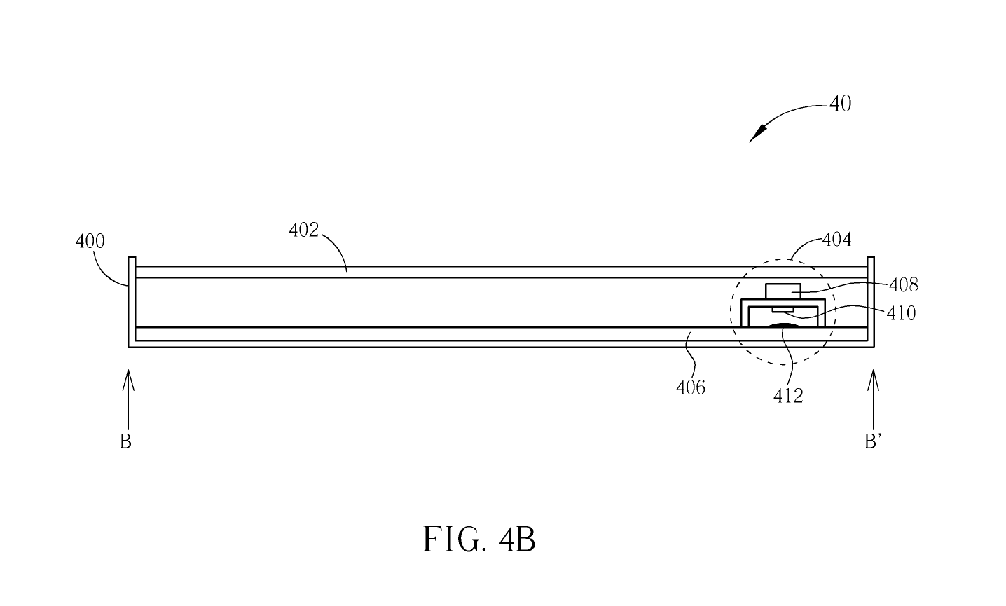

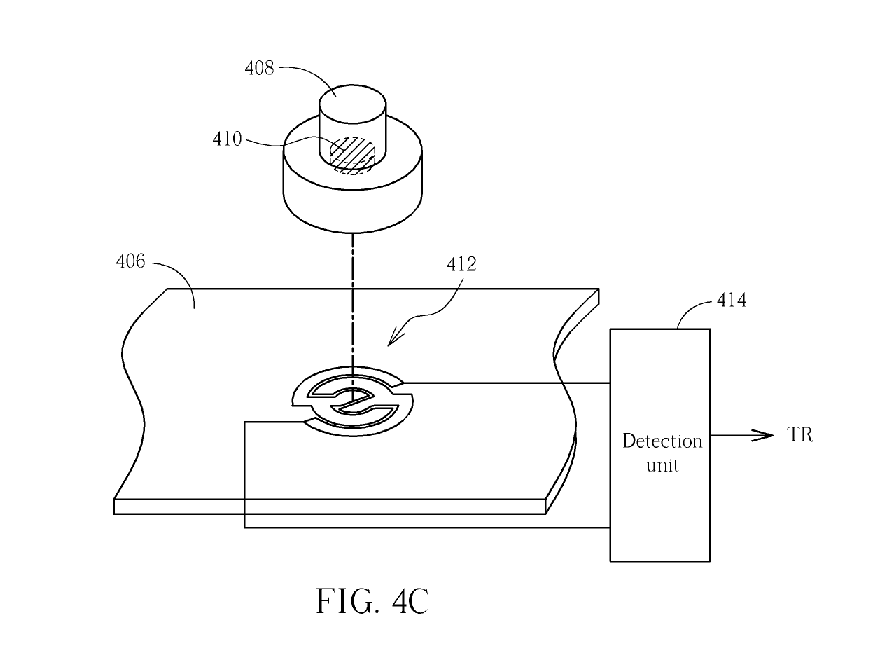

Next, please refer to FIG. 4A for illustrating the present invention. FIG. 4A is a schematic diagram of a touch display device 40 according to an embodiment of the present invention. The touch display device 40 is utilized for fulfilling both touch and display functions and includes a housing 400, a flexible monitor 402, and a keystroke device 404. The flexible monitor 402 can be an electronic paper or similar display panel with the flexible characteristic for displaying images and be formed with the housing 400 into an appearance of the touch display device 40. The keystroke device 404 is installed inside the housing 400 and under the flexible monitor 402. When the flexible monitor 402 is pressed by external forces at positions corresponding to the keystroke device 404, deformation of the flexible monitor 402 occurs and further presses the keystroke device 404, to make the keystroke device 404 to generate a trigger signal for a control module to determine touch events.

In short, since the flexible monitor 402 has the flexible characteristic, deformation of the flexible monitor 402 occurs by external forces when the flexible monitor 402 is pressed at positions corresponding to the keystroke device 404 and further presses the keystroke device 404, to make the keystroke device 404 to generate the trigger signal. Accordingly, please refer to FIG. 4B and FIG. 4C. FIG. 4B is a cross-sectional diagram of the touch display device 40 along point B to point B′, and FIG. 4C is a schematic diagram of the keystroke device 404. The keystroke device 404 includes a substrate 406, a cover 408, a conductive film 410, a trigger circuit 412 and a detection unit 414. The cover 408 is made of a flexible material such as rubber with the flexible monitor 402 installed on a top and the conductive film 410 distributed over a bottom. When the cover 408 is not pressed by external forces, the conductive film 410 distributed over the bottom keeps a specific distance with the trigger circuit 412. When the cover 408 is pressed by external forces, the conductive film 410 distributed over the bottom touches the trigger circuit 412 and then returns to the specific distance with the trigger circuit 412 after the external forces disappear. The trigger circuit 412 is composed of two metal lines. When the conductive film 410 touches the trigger circuit 412, the two metal lines are conducted via the conductive film 410. In other words, when the flexible monitor 402 is pressed at positions corresponding to the keystroke device 404, deformation of the flexible monitor 402 occurs by external forces and further presses the cover 408 to make the conductive film 410 touch the trigger circuit 412, and thereby the detection unit 414 generates a trigger signal TR.

From FIG. 4B and FIG. 4C, a structure of the keystroke device 404 is similar to that of a traditional mechanical key. However, note that the main objective of the present invention is not the structure or manufacturing method of the keystroke device 404, but to utilize the flexible characteristic of the flexible monitor 402 for fulfilling both touch and display functions with low cost. Those skilled in the art can make alternations and modifications accordingly. For example, to make sure that the user can press at correct positions corresponding to the keystroke device 404, an area corresponding to the keystroke device 404 on the flexible monitor 402 can display related information. For example, if the keystroke device 404 is used to active a program, the area corresponding to the keystroke device 404 on the flexible monitor 402 can display “program start”. In addition, when the cover 408 is not pressed by external forces, the conductive film 410 should keep the specific distance with the trigger circuit 412 of the keystroke device 404. Thus, the cover 408 is not limited to a flexible material and can sustain an interval with the trigger circuit 412 by structure of a metal spring, etc. Probably, the cover 408 can be agglutinated under the flexible monitor 402 and reach abovementioned goal by flexible characteristic of the flexible monitor 402.

On the other hand, when the trigger circuit 412 is conducted, the detection unit 414 outputs the trigger signal TR. The detection unit 414 can be composed of a power generator (e.g. a voltage source or a current source) or composed of complex circuits and operation elements. For example, a current source can be connected to a metal line of the trigger circuit 412 and an output terminal of the trigger signal TR is connected to the other metal line of the trigger circuit 412. Under such circumstances, when the conductive film 410 touches the two metal lines, current generated by the current source can be taken as the trigger signal TR.

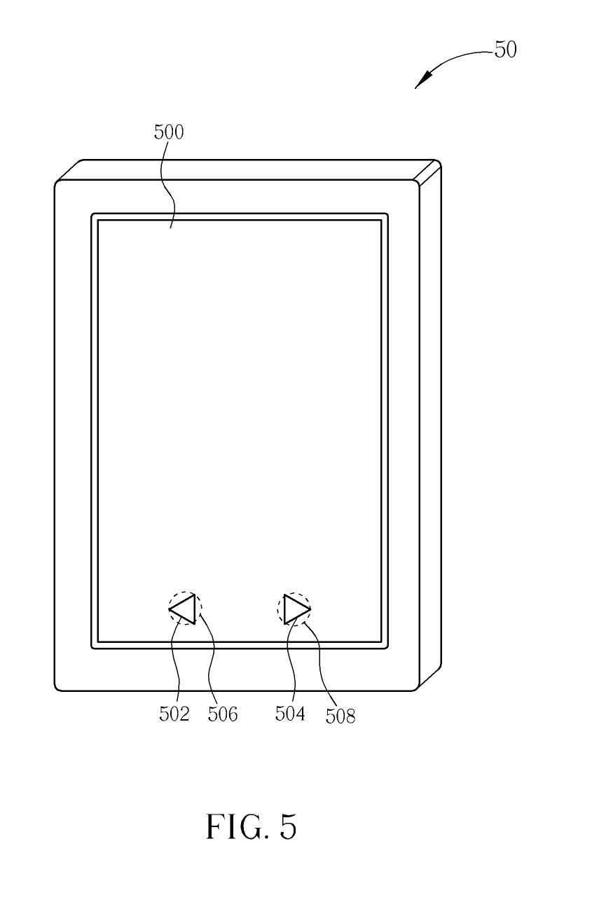

In addition, the abovementioned embodiment is for single keystroke device. In practice, according to requirements for different systems, multi-keystroke device can be derived. For example, please refer to FIG. 5. FIG. 5 is a schematic diagram of an electronic book 50 according to an embodiment of the present invention. The electronic book 50 applies the concept of the present invention and is composed of a flexible monitor 500 and keystroke devices 506 and 508 installed under the flexible monitor 500. When displaying contents of a book, an operation circuit of the electronic book 50 generates corresponding image signals to the flexible monitor 500 to display corresponding contents. Meanwhile, the operation circuit of the electronic book 50 displays images 502 and 504 corresponding to switch functions of previous page and next page respectively at positions corresponding to the keystroke devices 506 and 508 on the flexible monitor 500. Thus, when a user wants to switch to previous page, the user can press the image 502 on the flexible monitor 500. Then, deformation of the flexible monitor 500 occurs and further presses the keystroke device 506, to make the keystroke device 506 to generate a trigger signal correspondingly and thereby the operation circuit of the electronic book 50 switches contents of the book to previous page. Similarly, when the user wants to switch to next page, the user can press the image 504 on the flexible monitor 500. Then, deformation of the flexible monitor 500 occurs and further presses the keystroke device 508, to make the keystroke device 508 to generate a trigger signal correspondingly and thereby the operation circuit of the electronic book 50 switches contents of the book to next page.

Comparing with the electronic books with capacitive touch pads, because the keystroke devices 506 and 508 can be realized by traditional mechanical keystrokes, the electronic book 50 can reduce the cost of production and manufacturing efficiently. More importantly, during the operation process of the electronic book 50, if the keystroke devices 506 and 508 are not pressed, power consumption of the keystroke devices 506 and 508 are almost zero, which reduces power consumption efficiently and is an advantage for portable electronic devices such as electronic books.

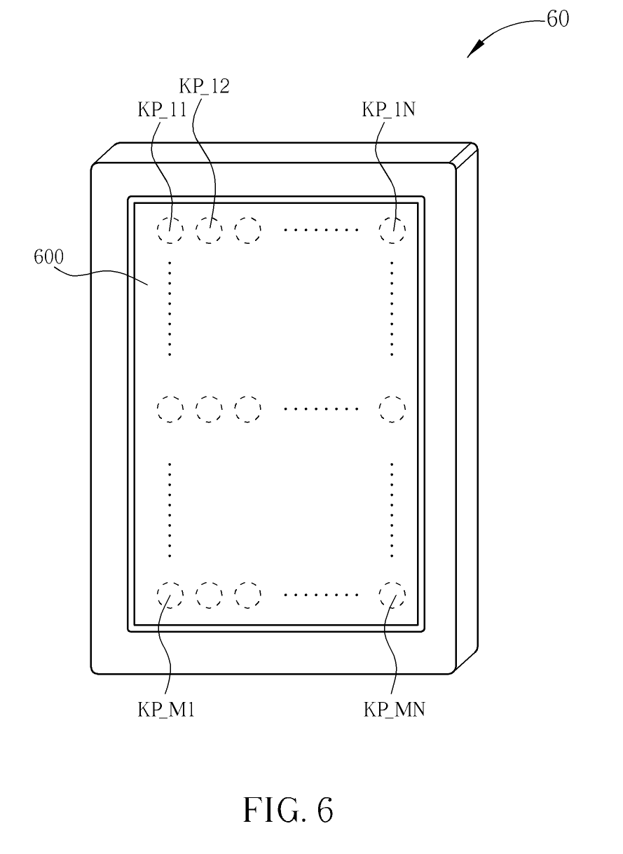

On the other hand, the present invention can realize a multi-touch application easily. For example, please refer to FIG. 6. FIG. 6 is a schematic diagram of a touch display device 60 according to an embodiment of the present invention. The touch display device 60 includes a flexible monitor 600 and keystroke devices KP_11˜KP_MN and can be used in portable computer systems, electronic books, smart phones, navigation devices, handheld game consoles, etc. As shown in FIG. 6, the keystroke devices KP_11˜KP_MN are arranged with a matrix under the flexible monitor 600 and are used for generating a trigger signal respectively. The operation concept of the touch display device 60 is similar to that of the touch display device 40 in FIG. 4A. That is, when a position corresponding to one of the keystroke devices KP_11˜KP_MN is pressed, deformation of the flexible monitor 600 occurs by external forces and triggers the keystroke device to generate a trigger signal. Because each keystroke device of the keystroke devices KP_11˜KP_MN is installed independently, if two or more than two keystroke devices are pressed at the same time, trigger signals are generated by keystroke devices correspondingly. Therefore, the control module can determine trigger events.

Note that, when the touch display device 60 is applied to an electronic device, designers should adjust the operating logic to realize a multi-touch operation. However, how to adjust the operating logic of the electronic device is not the main concern in the present invention, so the detailed description is omitted herein. The main objective of the present invention is to utilize the flexible characteristic of the flexible monitor, such that when the flexible monitor is pressed by external forces, deformation of the flexible monitor occurs and further presses the keystroke device installed under the flexible monitor, to fulfill both touch and display functions. Thus, comparing with the traditional touch control technique, the present invention can reduce production cost, power consumption and facilitate multi-touch application.

Besides, when the traditional touch display technique is easily affected by the environmental capacitance when applied for a large-size panel, and cannot timely reflect the variation of the touch event. In contrast, for a touch display application with a large-size panel, the present invention only needs to increase the number of keystroke devices and does not need extra detection time, which improves disadvantages in the prior art obviously.

In conclusion, the present invention utilizes the characteristic of the flexible monitor for realizing the touch display device with low cost, low power consumption, supporting multi-touch function easily and large-size application.

Those skilled in the art will readily observe that numerous modifications and alterations of the device and method may be made while retaining the teachings of the invention.

What is claimed is:

1. A touch display device comprising:
a housing;
a flexible monitor, installed on the housing; and
at least one keystroke device, installed inside the housing and under the flexible monitor, for generating at least one trigger signal;
wherein when the flexible monitor is pressed by an external force at positions corresponding to the at least one keystroke device, deformation of the flexible monitor occurs and further presses the at least one keystroke device, to make the at least one keystroke device to generate the at least one trigger signal.

2. The touch display device of claim 1, wherein a keystroke device of the at least a keystroke device comprises:
a substrate;
a trigger circuit, formed on the substrate, comprising a first metal line and a second metal line isolated with the first metal line;
a cover, installed on the substrate with a conductive film distributed over a bottom and kept a specific distance with the trigger circuit; and
a detection unit, coupled to the trigger circuit, for generating a trigger signal according to a conduction status of the first metal line and the second metal line.

3. The touch display device of claim 2, wherein when the cover is pressed by the external force, the conductive film touches the trigger circuit, for conducting the first metal line and the second metal line, to make the detection unit generate the trigger signal.

4. The touch display device of claim 2, wherein the cover is made of a flexible material.

5. The touch display device of claim 1, wherein the flexible monitor is an electronic paper.

6. An electronic device comprising:
an operation circuit, for generating an image signal;
a touch display device comprising:
a housing;
a flexible monitor, installed on the housing; and
at least one keystroke device, installed inside the housing and under the flexible monitor, for generating at least one trigger signal to the operation circuit to control the operation circuit;
wherein when the flexible monitor is pressed by an external force at positions corresponding to the at least one keystroke device, deformation of the flexible monitor occurs and further presses the at least one keystroke device, to make the at least one keystroke device to generate the at least one trigger signal.

7. The electrical device of claim 6, wherein a keystroke device of the at least a keystroke device comprises:
a substrate;
a trigger circuit, formed on the substrate, comprising a first metal line and a second metal line isolated with the first metal line;
a cover, installed on the substrate with a conductive film distributed over a bottom and kept a specific distance with the trigger circuit; and
a detection unit, coupled to the trigger circuit, for generating a trigger signal according to a conduction status of the first metal line and the second metal line.

8. The electrical device of claim 7, wherein when the cover is pressed by the external force, the conductive film touches the trigger circuit, for conducting the first metal line and the second metal line, to make the detection unit generate the trigger signal.

9. The electrical device of claim 7, wherein the cover is made of a flexible material.

10. The electrical device of claim 6, wherein the flexible monitor is an electronic paper.
